(19) United States
(12) Patent Application Publication
(10) Pub. No.: US 2026/0125004 A1
(43) Pub. Date: May 7, 2026

(54) SYSTEMS AND METHODS FOR REDUNDANCY IN RUNTIME VARIANTS

(71) Applicant: Rivian IP Holdings, LLC, Irvine, CA (US)

(72) Inventors: Tejas Abhay Chafekar, Edwards, IL (US); Justin William Vaughn Jones, Lake Forest, CA (US)

(21) Appl. No.: 19/179,222

(22) Filed: Apr. 15, 2025

Related U.S. Application Data
(60) Provisional application No. 63/717,191, filed on Nov. 6, 2024.

(51) Int. Cl. B60R 16/02; G06F 11/10

(52) U.S. Cl. CPC B60R 16/02; G06F 11/1004

(57) ABSTRACT

Electric vehicles, methods of operating electric vehicles, and methods of manufacturing electric vehicles are disclosed. A system includes a module configured to control an aspect of an electric vehicle, and a main controller including a variant manager. The variant manager is configured to retrieve redundant sets of runtime variants from respective memory storage locations, wherein a set of runtime variants affects how the module controls the aspect of the electric vehicle, determine an error-free set of runtime variants based on comparing the redundant sets of runtime variants, and apply the error-free set of runtime variants to the module. The electric vehicle may include a battery, and the module may be a battery management system configured to control the battery. Comparing the redundant sets of runtime variants may include performing a cyclic redundancy check.

### CROSS REFERENCE TO RELATED APPLICATIONS

This disclosure claims the benefit of copending, commonly-assigned U.S. Provisional Patent Application No. 63/717,191, filed Nov. 6, 2024, which is hereby incorporated by reference herein in its entirety.

### INTRODUCTION

The present disclosure is directed to systems and methods for redundancy in runtime variants. More specifically, the present disclosure is directed to redundantly storing sets of runtime variant settings in multiple hardware locations and to verifying the accuracy of selected runtime variant settings based on comparison of the redundant values stored across the multiple hardware locations.

### SUMMARY

Software systems may rely on variant-based configurations for interoperability. For example, a core application may be configurable to run with multiple sets of calibration settings. For a given core application, a particular set of calibration settings may be selected at various times, including when building a system relying on the application (e.g., a build-time variation) or when powering on (e.g., waking from a sleep state) a system relying on the application (e.g., a run-time variation). However, if a set of calibration settings is stored in memory, and any aspect of that memory gets corrupted, then the core application may load the corrupted calibration settings, which could affect the performance of the system relying on the core application.

In accordance with some embodiments of this disclosure, an electric vehicle (EV) is configured to operate a battery management system (BMS) and other electronic control units (ECUs) of the EV (any of which may be referred to as a module) using at least one core application and at least one set of calibration settings. The EV is configured to store the set of calibration settings in multiple locations. When booting the core application, installing the core application, or otherwise instantiating the set of calibration settings, the EV is configured to check the multiple locations to confirm that the core application applies the set of calibration settings without any errors.

For example, the multiple locations may include any two or more of: internal flash (e.g., DFLASH) memory of a CPU; external flash (e.g., EEPROM) memory; memory of a telematics control module (TCM); or memory of an ECU. For another example, the multiple locations may include at least two discrete locations on any one or more of the aforementioned locations. For another example, the multiple locations may include at least one remote location (e.g., a cloud server communicatively coupled to the EV).

For example, confirming that the core application applies the set of calibration settings without any errors may include reading at least two sets of settings stored at respective locations and implementing an error-checking mechanism, including a cyclic redundancy check (CRC) or evaluation of a checksum. For another example, confirming that the core application applies the set of calibration settings without any errors may include reading at least three sets of settings stored at respective locations and implementing a voting-based mechanism (e.g., to apply whichever setting is returned by the greatest number of sets of settings).

In accordance with some embodiments of this disclosure, electric vehicles, methods of operating electric vehicles, and methods of manufacturing electric vehicles are disclosed. An electric vehicle includes a module configured to control an aspect of the EV, and a main controller including a variant manager. The variant manager is configured to retrieve redundant sets of runtime variants from respective memory storage locations, wherein a set of runtime variants affects how the module controls the aspect of the EV, determine an error-free set of runtime variants based on comparing the redundant sets of runtime variants, and apply the error-free set of runtime variants to the module.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an electric vehicle having a main controller and memory, where the memory stores runtime variants at multiple locations and the main controller is configured to check the runtime variants;

FIG. 2 is an illustrative flowchart of a method for providing redundancy in runtime variant-based calibrations; and

FIG. 3 is an illustrative flowchart of a method for manufacturing an electric vehicle with redundancy in runtime variant-based calibrations.

### DETAILED DESCRIPTION

An electric vehicle (EV) typically includes an electric motor system. The electric motor system may include a battery pack and a battery management system (BMS). The BMS may be configured based on details of the battery pack, such as the battery chemistry, cooling architecture (e.g., including the quantities, types, and locations of thermistors), switch topology, available drive modes, or any other suitable factors.

The electric motor system, as well as other systems of the EV, may be operated according to one or more core software applications. To make a core application available to multiple EVs, or even to a single EV that is updated (e.g., based on servicing operations, including over-the-air (OTA) updates), the core application may be configured to run according to a set of calibration settings. However, based on differences between multiple EVs, differences introduced during any EV update, or based on any other factors, different calibration settings may need to be applied to the core application.

With multiple sets of different calibration settings stored in physical memory (e.g., at the EV or in a cloud-connected storage facility), there is the potential for the physical memory to be corrupted. Such corrupted physical memory could cause the core application to load a set of calibration settings that do not operate the EV as intended. Thus, approaches are needed to properly apply calibration settings to a core software application.

Calibration settings may be stored as runtime variants. As used herein, a runtime variant may refer to any one or more settings that are applied to a core application of an EV when turning on the EV (i.e., at runtime) to configure the core application for operating the EV as desired. One or more runtime variants may configure one or more aspects of the EV, including but not limited to the battery management system (BMS), electric motor drive, one or more zonal controller (e.g., a controller configured to manage a physical zone of the EV), one or more central processing units, a main controller, one or more thermal management systems (e.g., such as climate control or battery temperature management), any other suitable aspect of the EV, or any combination thereof.

Considering runtime variants that are related to an EV battery and/or motor, any possible hardware configuration (e.g., which may encompass possible changes to the battery pack or motor drive) may need a corresponding runtime variant. For example, compared to a reference configuration, any change in the total number of battery modules, total number of battery strings per module, or total number of thermistors in the battery pack may require an updated runtime variant. The updated runtime variant may accommodate a change as major as switching from one battery pack chemistry to another (e.g., from NCA to LFP) a change as minor as relocating, adding, or removing a single hardware component (e.g., a thermistor), or any other type of change. For another example, different operational modes (e.g., sport mode, comfort mode, economy mode, or off-road mode) may have respective runtime variants (e.g., to configure at least the BMS for operating in the corresponding mode). Moreover, each variant may be associated with one or more sub-variants that specify additional details of a configuration and/or relate the variant to supporting systems, such as other modules of the vehicle, lab-scale cars, simulation platforms, and end of line (EOL) routines.

While it may be possible to implement many, or all, of these possible variants as build-time variants (i.e., the variant is configured prior to building the EV and loaded onto the EV when building the EV), it may be advantageous to instead implement these variants as runtime variants (i.e., the variant is configured at any suitable time and loaded onto the EV when starting up the EV). For example, variant implementation as runtime variants may reduce build complexity, increase the flexibility of EV repair and OTA update capabilities, and/or increase the flexibility of memory storage locations that can be used in connection with the variants.

As mentioned, supporting many build-time variants can add time, cost, and complexity to the EV manufacturing process (e.g., such as when implementing the BMS PCB and the battery pack on the EV), e.g., because of needing to flash new software applications and/or variants onto memory of the EV at various manufacturing stages. Supporting many build-time variants may also increase cloud compute and storage costs, fleet management overhead, and network transmission costs during OTAs. Moreover, requiring multiple software flashes during a build (e.g., at various stages of the assembly line) may impose constrains on the hardware on which the software is being flashed. For example, if different types of EVs require different software flashes, then a manufacturing process cannot be standardized to apply one set of software to a main controller board that might otherwise go into each of those different types of EVs.

As a fleet of EV grows in size, these constraints on build-time variants become more challenging to manage. In accordance with this disclosure, embodiments are provided for implementing calibration settings as runtime variants rather than build-time variants. In particular, embodiments are provided for confirming that calibration settings stored as runtime variants are accurate prior to implementing these settings. For example, embodiments of this disclosure may be used to determine whether or not memory storing a runtime variant has been corrupted (e.g., prior to implementing the corrupted runtime variant and incurring an operational fault). In some embodiments, software-based systems of an EV are provided to accommodate a reduced number of runtime variants, thereby reducing storage requirements and management complexity without compromising on the ability to check that the runtime variants are correct. In some embodiments, correct runtime variants are retrieved (e.g., through an OTA transmission) and applied in response to determining that runtime variants stored in memory of the EV are corrupted.

As mentioned, runtime variants provide flexibility by supporting a single application program to have the ability to “select” the particular variant that the program needs to run (e.g., based on hardware of the EV and/or a particular operating mode of the EV). In some embodiments, the variant selection can be made using the unified diagnostic services (UDS) protocol or any other secure protocol. Accordingly, the time and cost of maintaining, storing and flashing multiple applications (one for each specific variant) can be minimized significantly, e.g., when compared to a system relying on build-time variants.

However, there are challenges when implementing runtime variants. For one challenge, to implement these multiple runtime variants, all the various build-time variants may have to coexist in the single application (e.g., as a consequence of simplifying the manufacturing process to reduce the flashing of multiple build-time variants). This may require that flash memory stored at the EV (or memory stored at a cloud location that is communicatively coupled) has enough volume to store all the possible different runtime variants, which may be enabled by optimizing the size of software packages to fit a prescribed volume of allocated memory. Thus, in accordance with some embodiments of this disclosure, systems and methods are provided for optimizing a core application to minimize the number of runtime variants and/or the file size of respective runtime variants as are required to operate an EV under many possible hardware/operational configurations. That is, a core application may be configured to support many (or all) of the possible run-time variants that may be desired to operate the EV in various modes (e.g., that may be selected by the user or automatically configured based on an environment or manner in which the EV is operating).

Another challenge associated with implementing runtime variants is that it is possible for memory storing the runtime variants to be corrupted, which would lead to incorrect calibrations being applied based on incorrect variant data. Such incorrect calibrations could lead to any number of operational faults associated with the EV. Thus, in accordance with some embodiments of this disclosure, systems and methods are provided for redundant storage of runtime variants and processors that ensure accuracy of runtime calibrations based on the redundancy in the runtime variant storage.

In particular, runtime variants that are important to EV operation may be stored in a static process. For example, these variants may be hard-coded on program flash memory (PFLASH) as part of an application (e.g., a core application executed by a main controller) hex image, which may be programmed during an EV build, during EV maintenance, and/or by OTA updates. These variants must be stored in multiple locations to provide failsafe operation in the case of corruption to the PFLASH or any other memory storing the runtime variants.

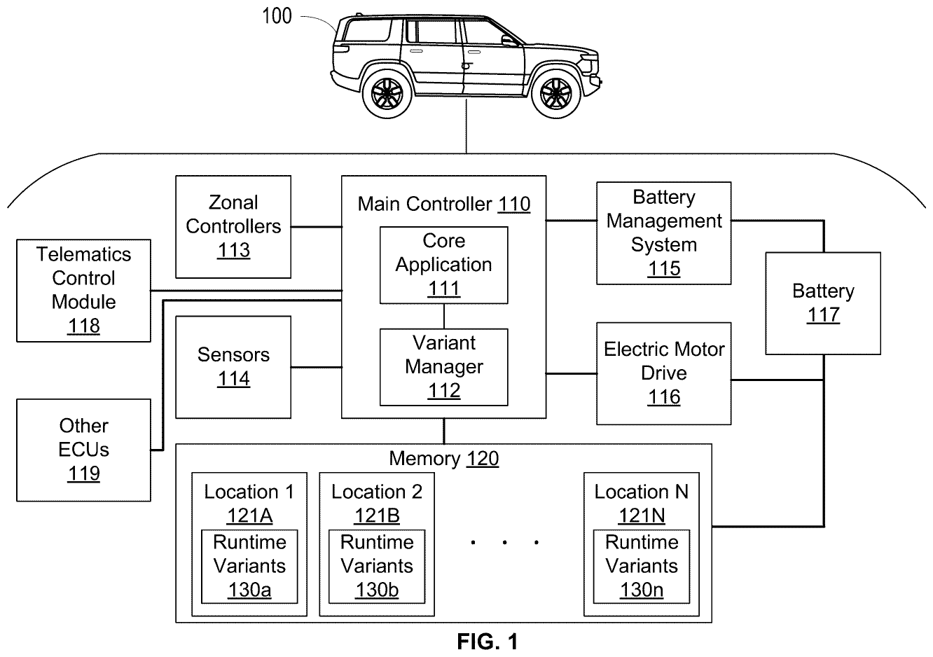

Persistent runtime variants or other calibration settings may be stored at data flash memory (DFLASH) of an internal CPU of an EV (e.g., at main controller 110 of the EV), at flash memory external to the CPU of the EV (e.g., at electrically erasable programmable read-only memory (EEPROM), serial NOR flash memory, or any other suitable external flash memory), at PFLASH (e.g., as mentioned above, where the hex image may be stored at memory of the main controller or any other suitable portion of memory), at off-system memory (e.g., memory on any suitable electronic control unit (ECU) that can be accessible by a network to which the EV is connected), or at any combination thereof. Any of those memories may be a respective location of memory 120, as shown in FIG. 1. The runtime variants or other calibration settings may be stored upon receipt during OTA updates (e.g., within an application hex file program or within a separate data hex, either or both of which may be written to PLFASH), may be stored upon flashing during factory assembly (e.g., using UDS during an EOL build), may be dynamically stored in response to an ad-hoc transmission (e.g., by a network, in response to a request from a main controller, telematics control module (TCM), or any other system component), or may be stored based on any combination thereof.

In some embodiments, runtime variants may provide calibrations based on a set of vehicle-wide parameters and options that may be specific to a particular make/model, operational mode, or even a specific instance of an EV. For example, these vehicle-wide parameters and options may be written to the TCM, main controller, or any other suitable component of the EV during factory assembly (e.g., during EOL builds) and/or when servicing the EV. A communications bus (e.g., including an ethernet-based connection or a controller area network-based connection) of the EV may broadcast the vehicle-wide parameters to every zonal controller and/or ECU of the EV that operates based on the vehicle-wide parameters and at least one corresponding calibration. In some embodiments, one or more ECUs coupled to the TCM or main controller (noting that the TCM may itself be the main controller, i.e., TCM 118 may be inside main controller 110, despite being shown as different components in FIG. 1) may receive the set of vehicle-wide parameters over the communication bus and save a copy of the parameters to respective memories of the one or more ECUs, such that these ECUs can access the parameters even if the TCM or main controller is offline/asleep.

In accordance with embodiments of this disclosure, to accommodate how runtime variant options can change at any time and must be correct when loaded onto operational systems of an EV, systems and methods are provided for accurate storage and implementation of runtime variant options. In particular, the runtime variation data is stored at multiple locations and error-checking mechanisms are used to inspect the respective sets of data stored at the multiple locations and confirm data integrity. After confirming the data integrity (e.g., based on CRC or other suitable error-checking approaches), the variant data may be loaded onto a core application, BMS, and/or ECUs of the EV such that the EV can be operated as intended.

To support systems and methods of this disclosure, downstream ECUs (i.e., ECUs that receive variant data from the TCM or main controller, such as any of the other ECUs 119) may be coupled to a “variant manager” (VM) application (e.g., variant manager 112) that is coupled to one or more software components (SWC) and configured to manage the set of runtime variant parameters needed by the downstream ECUs and/or other ECUs of the EV. The ECUs and related software components are configured to retrieve runtime variant options from the VM. The ECUs and related software components are further configured to apply a failsafe set of runtime variant parameters if the VM does not provide a valid (e.g., error-free and compatible with the EV on which the ECUs are located) configuration. The VM, the ECUs, or both, may include a variant checker for determining that the runtime variant is compatible with a current state of the EV and for determining that the runtime variant is error-free.

In some embodiments, the VM is configured to initially boot with an initial set of runtime variant values (e.g., which may be representative of a standardized state that may or may not include full operation of the vehicle). This initial set of values may be configured such that after applying the initial set of values, no downstream SWCs are provided a valid variant, which forces the SWCs to be dormant until a valid configuration is subsequently written to each of the ECUs executing the respective SWC. Such an initial boot strategy prevents old (e.g., from a prior boot) runtime variant values from being loaded upon startup of the EV. This strategy may, e.g., be useful because there could be changes to the EV that have occurred since the prior boot and require updated runtime variant values.

In some embodiments, there are at least three data-handling requirements of the VM, which are listed as follows. (1) All data stored by the VM may be protected by an error-checking mechanism (e.g., CRC). Thus, the hardware (e.g., a main controller or TCM) configured to execute the VM may include processing circuitry configured to retrieve the data stored by the VM and perform the error-checking procedure. (2) All external (e.g., using CAN) and internal (e.g., using a runtime environment (RTE)) communication to and from the VM may be end-to-end protected. Thus, errors to the data may not be injected during communication to and from the VM. (3) The VM may be configured to only execute on a lock-step-enabled CPU core (e.g., main controller 110 may include a lock-step-enabled CPU core). The lock-step-enabled CPU core may be configured to detect discrepancies between respective sets of runtime variation parameters.

In some embodiments, memory associated with BMS software may be staggered (e.g., distributed across multiple, non-adjacent physical locations, optionally with redundancy) to prevent storing of runtime variation data and/or corresponding calibrations in contiguous memory locations. Furthermore, important calibrations may be duplicated at respective instances of these non-contiguous blocks of memory to provide redundancy. The VM and/or the BMS software may be configured to perform a plausibility check (e.g., using CRC or any other error-checking approach) on the runtime variation data and/or the corresponding calibrations to confirm the validity of these calibrations. This redundancy can prevent a corrupted block of memory from applying incorrect calibrations to the core EV application, the BMS software, or any other ECU or application of the EV.

An illustrative method for providing redundancy during runtime calibrations is provided as follows. This method is described in connection with the BMS (e.g., battery management system 115), but this method may similarly be used with any ECU zonal controller, motor drive, or other aspect of an EV (e.g., in connection with any other functional components shown in FIG. 1). In connection with this method, a set of battery parameters are invoked as the illustrative runtime parameters, but this method may be similarly applied to any suitable runtime parameter. This illustrative method begins with production-based operations. However, other embodiments of this method may begin at the EV boot up (i.e., at runtime), as described below, and may be executed based on, or independent of, these production-based operations.

At the EOL build for a main EV board (e.g., corresponding to a main controller or a TCM), the VM is configured to boot with an initial set of runtime variant values. This step may force the VM to write runtime variants to one or more modules of an EV each time that the EV is turned on or otherwise booted, e.g., out of a sleep state.

At the EOL build for a battery pack, the battery parameters are written to the BMS (e.g., which is stored at memory within the battery pack) via UDS. The VM may be configured to write this data to both DFLASH and EEPROM of the battery pack, and the VM may be further configured to ensure that the data is written correctly to both memory locations. For example, battery 117 may include at least two respective locations of memory 120, and the VM may write the battery parameters to each of the at least to respective locations. During such a write process, the VM may be configured to use CRC to determine that the data is written correctly.

At the EOL build for an EV, the battery parameters may be included in the list of vehicle-wide runtime parameters that are written to the main controller or TCM (e.g., via a set of runtime variants) by the VM. The main controller or TCM may then broadcast the battery parameters to downstream ECUs, including the BMS. The VM or any of the downstream ECUs may be configured to write the vehicle-wide parameters to a different portion of DFLASH compared to where the battery parameters were written at the EV board or battery pack builds.

After the EOL builds of the main EV board, the battery pack, and the EV, the VM may be configured to check whether the battery parameters stored at one or more locations of the DFLASH of the battery pack, at the EEPROM of the battery pack, and at the vehicle-wide runtime parameters of the main controller or TCM are in agreement. In some embodiments, the battery parameters may be stored at more locations or at fewer (but at least two) locations. Moreover, determining that the battery parameters are in agreement may include verifying that any two or more sets of parameters stored at separate memory locations are identical. Alternatively, determining that the battery parameters are in agreement may include a voting-based system in which the battery parameters are read from at least three locations, and the values that appear most frequently are determined to be the correct values. If the VM does not determine that the battery parameters are correct (e.g., if the VM determines that there is at least one incorrect or uncertain battery parameters), then the VM may be configured to request a fallback state for the BMS and the VM may issue a diagnostic trouble code (DTC) or other error message. For example, the fallback state may prevent the BMS from closing contactors or activating a high voltage energy supply.

The illustrative method can also include the VM performing, at every boot of the EV, the same parameter check as occurs after the EOL builds of the main EV board, battery pack, and EV. This operation of the method may include preventing one or more SWCs from being configured and/or from performing any operational function (e.g., related to driving the EV, as opposed to booting the EV) until the check is completed successfully.

FIG. 1 shows a high-level block diagram of an EV 100 configured to incorporate runtime variants with redundancy, in accordance with some embodiments of this disclosure. The EV 100 includes a main controller 110 (which may, e.g., be a TCM, even though TCM 118 is shown as being coupled to the main controller for illustrative purposes, or which may be any other suitable controller) which includes at least a core application 111 (e.g., the core application configured to operate at least part of EV 100) and a VM 112 (e.g., the variant manager configured to determine that the variants are accurate and to write variants to components of EV 100, including any of the components shown in FIG. 1). The main controller 110 may be configured to use the VM 112 to check (e.g., for accuracy and compatibility) and load runtime variants into the core application 111, and/or into any other component of EV 100, including at least those other components shown in FIG. 1. EV 100 is configured to operate based on the settings applied by core application 111. In particular, the VM 112 may be configured to retrieve any suitable number (i.e, “n”) of runtime variants from respective locations of memory (e.g., “N” locations, which may, but need not, correspond to the “n” runtime variants) and to configure the runtime variants onto modules of the EV only after checking and confirming that the variants include correct calibration data. For example, the runtime variants may be any (or all) runtime variants 130a through 130n, where n is any suitable integer, and the runtime variants may be stored at respective memory locations 121A through 121N, where N Is any suitable integer. Each respective location of memory 120 may be any type of memory listed in this disclosure, or any other suitable physical memory. A respective location of memory 120 may be a cloud storage repository (e.g., any physical memory that is not located within EV 100), in which case it will be understood that EV 100 can be communicatively coupled to the cloud storage repository to retrieve the corresponding runtime variants stored in the memory.

Though not explicitly shown in FIG. 1, it will be understood that EV 100 includes a communications bus to provide the communicative coupling (e.g., as shown by connecting lines) between respective components of EV 100. That is, the communications bus may be coupled to any combination of main controller 110, zonal controllers 113, sensors 114, BMS 115, electric motor drive 116, battery 117, TCM 118, other ECUs 119, and memory 120. As such, though explicit communicative couplings are not shown between every possible combination of the components shown in FIG. 1, it will be understood that any of these components may be communicatively coupled to any other of these components over the communications bus.

In some embodiments, the core application is configured to accommodate the runtime variants. For example, the core application may be coded for a target file size and/or for a target level of cross-compatibility with various possible EV types and configurations. The core application may also be configured to receive the runtime variants and implement no more than a threshold amount of operational changes based on the runtime variants.

As shown, the main controller 110 is connected to memory 120 to retrieve the runtime variants 130a though 130n. The memory 120 includes multiple discrete locations 121A through 121N, each of which may be a respective memory space, and/or a respective portion of a memory space. When the memory locations used in connection with storing runtime variants are discrete portions of a single memory space, these locations may be non-contiguous memory blocks. For illustrative purposes, the memory 120 is shown as being separate from the main controller 110 and the various other modules of the EV 100. However, in addition to being stored at a standalone location, portions of this memory may be stored at the main controller 110 and/or at any of the other modules of the EV. For example, at least one or two respective locations of memory 120 may be stored within battery 117 (e.g., a battery pack), as described above in connection with the battery parameter runtime variants.

As shown, the EV also include other components including zonal controllers 113, sensors 114, a battery management system 115, an electric motor drive 116, a telematics control module 118, other ECUs 119, or any other components. Any of those components shown in FIG. 1, or any other electronically controlled component of EV 100, may be referred to herein as a module. Any two or more of the components shown in FIG. 1 may be collocated (e.g., on a single circuit board or other shared electronic system). The main controller 110 is coupled to these modules (e.g., via a communications bus) to configure them with a particular set of runtime variants (e.g., which corresponds to one, or at least two, runtime variants 130a through 130n), after confirming that the runtime variants have correct values. For one example, the main controller 110 may support the intended operation of the battery 117 by the BMS 115 and/or the electric motor drive 116 based on the incorporation of correct runtime variants into the core application 111.

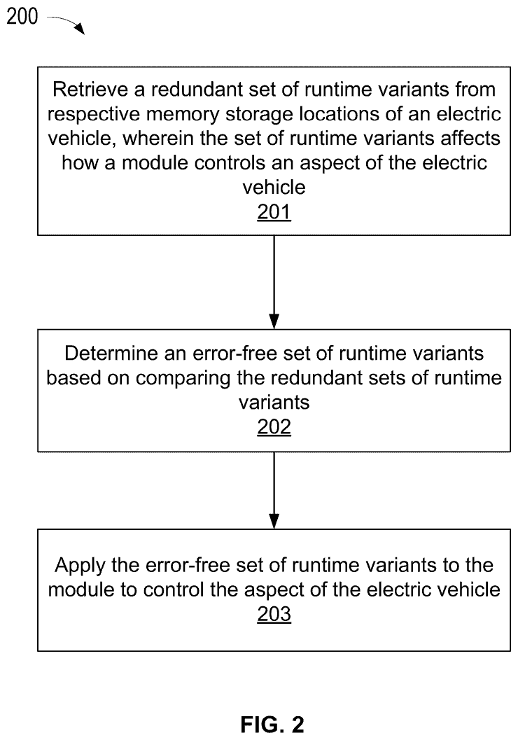

FIG. 2 shows an illustrative method 200 for providing redundancy in runtime variant-based calibrations, in accordance with some embodiments of this disclosure. In connection with method 200, the runtime variants may store battery parameters (e.g., based on a specific battery chemistry, battery pack arrangement, state of battery health, state of charge, or any other suitable battery parameter), telematics control module parameters, and/or any other suitable EV parameters. Method 200 may be implemented, e.g., on EV 100, in connection with main controller 110, memory 120, and at least one other module of EV 100. In some embodiments, method 200 is implemented at a main controller 110 (e.g., at a circuit board including at least the main controller) of an EV, e.g., at variant manager 112 of main controller 110.

At step 201, a redundant set of runtime variants (e.g., any one or more sets of runtime variants 130a through 130n) are retrieved from respective memory storage locations (e.g., any one or more locations 121A through 121N) of an EV (e.g., EV 100). The set of runtime variants affects how a module (e.g., any one or more of core application 111, zonal controllers 113, sensors 114, a battery management system 115, an electric motor drive 116, a telematics control module 118, other ECUs 119, or any other module of an EV) controls an aspect of the EV. In some embodiments, the memory storage of an EV may refer to a cloud-based memory storage (e.g., that is associated with a make, model, or other identifier of the EV).

The respective memory storage locations may be one or more storage locations of a main controller, one or more storage locations of an ECU or module that is operated based on the runtime variants, any other suitable storage location such as a cloud-based repository, or any combination thereof. As mentioned, the runtime variants may be written to various storage locations during EOL manufacturing of a main board, battery pack, and/or EV. The runtime variants may otherwise or additionally be written to various storage locations via an OTA update or during vehicle servicing.

In some embodiments, prior to the operations at step 201, method 200 includes booting a VM (e.g., VM 112) and applying an initial calibration (e.g., an initial set of runtime variant data) to any one or more modules of an EV (e.g., any of the modules of EV 100, as shown in FIG. 1). The initial calibration may cause the one or more ECUs or modules to be inoperable or operable with limitations until a set of runtime variants are verified (i.e., checked for accuracy, e.g., as per the operations at step 202) and loaded onto the one or more modules (e.g., as per the operations at step 203).

Method 200 also includes, at step 202, to determine an error-free set of runtime variants based on comparing the redundant sets of runtime variants. In other words, step 202 may include checking that the runtime variants are correct. For example, the VM may check that the runtime variants are correct using CRC or a rule-based voting system (e.g., in which the most frequently-read data is determined to be correct, or in which unanimous agreement must be received in order to determine that the set of runtime variants is error-free). The VM may be configured to cause a module to maintain the initial state or to apply a fallback state if the VM determines that there is an error (e.g., based on an inconstancy of the retrieved data) in the runtime variant data. That is, at step 202, the VM may determine that running an EV using a core application (e.g., core application 111) in connection with the runtime variant data would cause the EV to operate as intended.

Method 200 also includes, at step 203, to apply the runtime variants to a core application (e.g., core application 111) executed by a main controller (e.g., main controller 110, which may itself be a TCM, or which may be coupled to a TCM such as TCM 118) of the EV. In some embodiments, the runtime variants are also applied to one or more applications executed by any suitable number of modules of the EV, including but not limited to the BMS or other ECUs of the EV. By checking for accuracy (e.g., at step 202) and then applying the accurate runtime variants (e.g., at step 203), the VM may cause the EV to operate as intended.

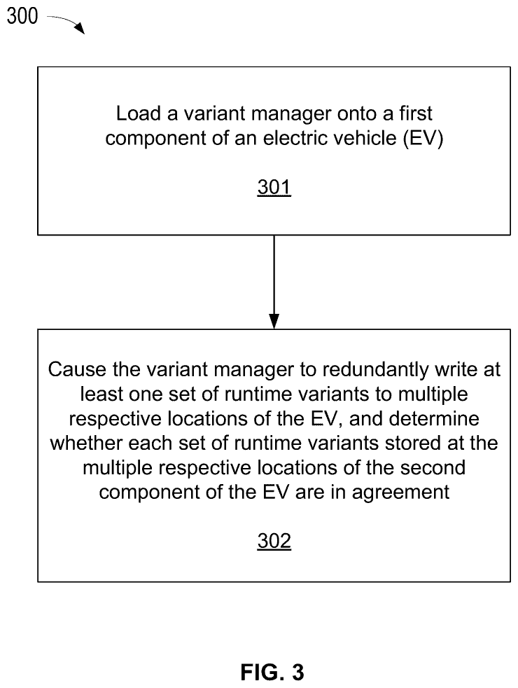

FIG. 3 shows an illustrative method 300 for manufacturing an electric vehicle with redundancy in runtime variant-based calibrations, in accordance with some embodiments of this disclosure. In connection with method 300, the runtime variants may store battery parameters (e.g., based on a specific battery chemistry, battery pack arrangement, state of battery health, state of charge, or any other suitable battery parameter), telematics control module parameters, and/or any other suitable EV parameters. Method 300 may be implemented, e.g., when manufacturing EV 100, in connection with main controller 110, memory 120, and at least one other module of EV 100. In some embodiments, method 300 is implemented at a main controller 110 (e.g., at a circuit board including at least the main controller) of an EV, e.g., at variant manager 112 of main controller 110. Method 300 can occur at any suitable time in the manufacturing process of an EV, but typically occurs after other modules (e.g., any module described in this disclosure, or any other suitable module) of the EV are installed.

At step 301, method 300 includes loading a variant manager (e.g., variant manager 112) onto a first component (e.g., main controller 110) of an electric vehicle (e.g., EV 100).

At step 303, method 300 includes causing the variant manager to redundantly write at least one set of runtime variants to multiple respective locations of the EV (e.g., the same runtime variants are stored at multiple discrete memories of main controller 110, or at multiple discrete locations of a memory of main controller 110, and/or stored at battery management system 115 or any other module of the EV), and determine whether each set of runtime variants stored at the multiple respective locations of the second component of the EV are in agreement. For example, redundantly writing the set of runtime variants may include writing that set of runtime variants to at least two respective locations 121 of memory 120. For another example, determining whether each set of runtime variants are in agreement may include performing a cyclic redundancy check or any other suitable error-checking process.

The processes described above are intended to be illustrative and not limiting. One skilled in the art would appreciate that the steps of the processes described herein may be omitted, modified, combined and/or rearranged, and any additional steps may be performed without departing from the scope of the invention.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations thereto and modifications thereof, which are within the spirit of the following claims.

What is claimed is:

1. A system comprising:
a module configured to control an aspect of an electric vehicle (EV); and
a main controller comprising a variant manager configured to:
retrieve redundant sets of runtime variants from respective memory storage locations, wherein a set of runtime variants affects how the module controls the aspect of the EV;
determine an error-free set of runtime variants based on comparing the redundant sets of runtime variants; and
apply the error-free set of runtime variants to the module.

2. The system of claim 1, further comprising:
a battery,
wherein the module comprises a battery management system configured to control the battery.

3. The system of claim 1, wherein comparing the redundant sets of runtime variants comprises performing a cyclic redundancy check on the redundant sets of runtime variants.

4. The system of claim 1, wherein the main controller is configured to boot the module into an initial state prior to applying the error-free set of runtime variants, wherein the initial state provides for limited operation of the module.

5. The system of claim 1, wherein the respective memory storage locations comprise at least one location at the module and at least one other location at the main controller.

6. The system of claim 1, further comprising a communications bus to communicatively couple the module to the main controller.

7. The system of claim 1, wherein the main controller comprises a lock-step-enabled CPU core configured to execute the variant manager.

8. The system of claim 1, wherein the variant manager is further configured to request the error-free set of runtime variants from a cloud-connected storage facility in response to determining that the retrieved redundant sets of runtime variants do not comprise the error-free set of runtime variants.

9. A method of operating an electric vehicle (EV), the method comprising:
retrieving redundant sets of runtime variants from respective memory storage locations of the EV, wherein a set of runtime variants affects how a module controls an aspect of the EV;
determining an error-free set of runtime variants based on comparing the redundant sets of runtime variants; and
applying the error-free set of runtime variants to the module to control the aspect of the EV.

10. The method of claim 9, wherein the EV comprises a battery, and the module comprises a battery management system configured to control the battery.

11. The method of claim 9, wherein comparing the redundant sets of runtime variants comprises performing a cyclic redundancy check on the redundant sets of runtime variants.

12. The method of claim 9, further comprising booting the module into an initial state prior to applying the error-free set of runtime variants, wherein the initial state provides for limited operation of the module.

13. The method of claim 9, wherein the respective memory storage locations comprise at least one location at the module and at least one other location at a main controller.

14. The method of claim 9, wherein applying the error-free set of runtime variants to the module comprises communicating, over a communications bus, the error-free set of runtime variants to the module from a main controller comprising a variant manager.

15. The method of claim 9, wherein the retrieving, determining, and applying are executed by a lock-step-enabled CPU core configured to execute a variant manager application.

16. The method of claim 9 further comprising requesting the error-free set of runtime variants from a cloud-connected storage facility in response to determining that the retrieved redundant sets of runtime variants do not comprise the error-free set of runtime variants.

17. A method of manufacturing an electric vehicle (EV), the method comprising:
loading a variant manager onto a first component of the EV; and
causing the variant manager to:
redundantly write at least one set of runtime variants to multiple respective locations of a second component of the EV; and
determine whether each set of runtime variants stored at the multiple respective locations of the second component of the EV are in agreement.

18. The method of claim 17, wherein the first component comprises a main controller board of the EV and second component comprises a battery pack of the EV.

19. The method of claim 18, wherein causing the variant manager to redundantly write the at least one set of runtime variants comprises:
writing the at least one set of runtime variants to the first component of the EV, and
causing the first component of the EV to broadcast the at least one set of runtime variants to the multiple respective locations of the second component of the EV.

20. The method of claim 17, further comprising, in response to determining that each set of runtime variants stored at the multiple respective locations of the second component of the EV are in agreement, causing the variant manager to configure a core application of the EV based on the at least one set of runtime variants.
